(19) United States
(12) Patent Application Publication
(10) Pub. No.: US 2017/0009589 A1
(43) Pub. Date: Jan. 12, 2017

(54) GAS TURBINE ENGINE BLADE WITH INCREASED WALL THICKNESS ZONE IN THE TRAILING EDGE-HUB REGION

(71) Applicant: Siemens Energy, Inc., Orlando, FL (US)

(72) Inventors: Mohit Gupta, Kissimmee, FL (US); Jonathan A. Mount, Oviedo, FL (US); Scott Michael Widrig, Pembroke, VA (US); Ravishankar P. Angal, Oviedo, FL (US)

(21) Appl. No.: 14/936,926

(22) Filed: Nov. 10, 2015

Related U.S. Application Data
(60) Provisional application No. 62/190,459, filed on Jul. 9, 2015.

(51) Int. Cl. F01D 5/14; F01D 5/18

(52) U.S. Cl. CPC F01D 5/147; F01D 5/18; F05D 2220/32; F05D 2240/304; F05D 2240/80; F05D 2260/2214

(57) ABSTRACT

Airfoil outer wall thickness of a gas turbine engine blade is increased in the zone that is proximate the trailing edge and blade hub by forty to sixty percent (40-60%) greater than comparable greatest wall thickness anywhere else along the trailing edge from outboard that zone all the way to the blade tip. The increased thickness zone includes a transition zone that bridges the respective airfoil outer wall thicknesses proximate the hub and tip of the blade. Some embodiments also incorporate pedestals with compound curve fillets in the increased wall thickness zone. The increased thickness zone reduces blade cracking propensity and enhances service life.

### PRIORITY CLAIM

This application claims the benefit of priority under U.S. Provisional Application No. 62/190,459, filed Jul. 9, 2015, and entitled “Blade for Gas Turbine Engine”, which is incorporated by reference herein.

### TECHNICAL FIELD

The invention relates to gas turbine engine rotating blades. More particularly, the invention relates to gas turbine engine blades having an increased airfoil outer wall thickness zone proximate the hub and trailing edge (TE), which reduces blade-cracking propensity and enhances blade service life.

### BACKGROUND

Repetitive or cyclic loading of gas turbine engine blades during service operation may induce metal fatigue cracks in the blade substrate. Commonly recognized fatigue mechanisms are thermo-mechanical fatigue (TMF), high-cycle fatigue (HCF) and low-cycle fatigue (LCF). TMF thermal strain is attributable to blade thermal expansion and contraction experienced during large temperature changes, such as induced during engine powering on or off or changes in engine load. TMF mechanical strains are associated with centrifugal loads during engine speed changes or output load, which are cumulative with the thermally induced strains. HCF is attributed to low-amplitude, high-frequency strains induced by blade flexure during engine operation, which can induce crack propagation during ongoing engine operation. LCF is characterized by high-amplitude, low-frequency plastic strains in regions of stress concentration.

One observed blade substrate zone that is susceptible to LCF/TMF cracking is often in a region proximate the blade airfoil trailing edge and blade hub platform, and associated pedestals that are formed within the airfoil interior, which bridge opposed interior wall surfaces. A crack initiating at one location within this region has propensity to grow or propagate as the blade flexes cyclically during engine shaft rotation under HCF operational conditions. Conventional wisdom for blade design is to minimize turbine engine blade airfoil outer wall thickness, in order to minimize rotating mass and thermal mass TMF influences. Under such conventional wisdom, thin airfoil wall thickness also reduces airfoil cross section, which is thought to enhance aerodynamic efficiency. Past proposed solutions to reduce crack propensity in the region proximate the blade airfoil trailing edge and blade hub platform has been to incorporate a constant or compound curve hub fillet around all or part of the airfoil wall and blade platform junction, while maintaining a relatively constant airfoil wall thickness along the entire trailing edge from hub to blade tip.

### SUMMARY OF INVENTION

Despite conventional design wisdom to minimize turbine engine blade trailing edge (TE) thickness, in order to reduce rotating mass-induced cyclic fatigue and increase aerodynamic efficiency, local thickening of the airfoil outer or side wall zone in the region proximate the TE and hub actually reduces, rather than increases, peak stress at previously observed crack locations around the hub to airfoil wall TE region. Furthermore, increasing local thickening of the airfoil wall zone along the TE from the hub to approximately eight to ten percent (8-10%) of the airfoil stand length, which in some embodiments encompass typically the first five to eight TE pedestals, reduces likelihood of cracks at pedestal/side wall junction regions. Local thickening of the TE reduces the peak stress at the pedestal outer or side wall location and crack formation, which in turn enhances component service life. In cast turbine blades, the TE airfoil wall thickening zone not only reduces stress, but also enhances the casting alloy grain structure in a way to improve creep ductility, by changing the relative rates of solidification of the airfoil TE and the adjacent blade platform mass. The thickened TE zone drives the solidification relative rates in a way that enhances alloy grain structure and ductility, which beneficially retards crack propagation rate.

Exemplary gas turbine engine blade embodiments described herein increase airfoil wall thickness in a zone that is proximate the trailing edge (TE) and hub by forty to sixty percent (40-60%) greater than the comparable greatest wall thickness anywhere else along the trailing edge from outboard that zone all the way to the blade tip. Some embodiments also incorporate pedestals with compound curve fillets in the increased wall thickness zone. While increasing airfoil wall thickness anywhere on a turbine blade is counterintuitive to known conventional blade design, it has been found to reduce blade cracking propensity in the same zone, enhancing service life, with no significant change in blade aerodynamic efficiency.

Exemplary embodiments of the invention feature a turbine engine blade, including a hub with a blade platform and an elongated airfoil portion. The airfoil has an outer wall, also called a side wall, delimiting a pressure side, a suction side, a leading edge, and a trailing edge on its exterior surface. The airfoil outer wall delimits an airfoil interior on its interior surface. Airfoil outer wall thickness is established between the respective interior and exterior surfaces. A proximal end of the outer wall is coupled to the blade platform from the leading edge to the trailing edge. Correspondingly, a distal end of the outer wall defines a blade tip. The airfoil defines a span dimension (also referred to as a stand length, or height) between its proximal and distal ends. The blade has a hub fillet circumscribing and joined to the airfoil outer wall exterior surface at the proximal end, which is also joined to the blade platform. In a turbine blade casting, the hub fillet is integrally cast with the airfoil outer wall and the blade platform, adding extra material thickness to the blade region where the exterior surface of the hub outer wall and the blade platform converge. In the increased thickness zone, which has a zone proximal end adjoining the blade platform and a zone distal end, the zone's proximal end outer wall thickness, excluding adjoining hub fillet thickness, is approximately forty to sixty percent (40-60%) greater along the trailing edge for approximately eight to ten percent (8-10%) of total airfoil span than the comparable greatest wall thickness anywhere else along the trailing edge from outboard that zone all the way to the distal tip. The corresponding outer wall thickness in the increased thickness zone transitions from the thicker region proximate the hub to that of the outboard thinner region that is proximate the tip.

Other exemplary embodiments of the invention feature a turbine engine blade, including a hub with a blade platform and an elongated airfoil portion. The airfoil has an outer wall, which is also referred to as a side wall, delimiting a pressure side, a suction side, a leading edge, and a trailing edge on its exterior surface. The airfoil outer wall delimits an airfoil interior on its interior surface. Airfoil outer wall thickness is defined between its respective interior and exterior surfaces. A proximal end of the outer wall is coupled to the blade platform from the leading edge to the trailing edge. Correspondingly, a distal end of the outer wall defines a blade tip. The airfoil defines a span dimension (also referred to as a stand length, or height) between its proximal and distal ends. The blade has a hub fillet circumscribing and joined to the airfoil outer wall exterior surface at the proximal end, which is also joined to the blade platform. In a turbine blade casting, the hub fillet is integrally cast with the airfoil outer wall and the blade platform, adding extra material thickness to the blade region where the exterior surface of the hub outer wall and the blade platform converge. In this embodiment, a plurality of elongated pedestals spans the airfoil interior, and is oriented along the airfoil stand length between the proximal and distal ends. The respective pedestals have an elongated cross section, defining a major axis that is generally perpendicular to stand length dimension of the airfoil, and a minor axis that is generally parallel with the airfoil stand length dimension. First and second ends of each respective pedestal is coupled to respective corresponding opposed interior surfaces of the outer wall pressure and suction sides, proximate the trailing edge, by pedestal fillets. In the increased outer wall thickness zone, the airfoil proximal end outer wall thickness, excluding adjoining hub fillet thickness, is approximately forty to sixty percent (40-60%) greater along the trailing edge for approximately eight to ten percent (8-10%) of total airfoil span than the comparable greatest wall thickness anywhere else along the trailing edge from outboard that zone all the way to the blade tip. The corresponding outer wall thickness in the increased thickness zone transitions from the thicker region proximate the hub to that of the outboard thinner region that is proximate the tip.

The respective features of the exemplary embodiments of the invention that are described herein may be applied jointly or severally in any combination or sub-combination.

### BRIEF DESCRIPTION OF DRAWINGS

The exemplary embodiments of the invention are further described in the following detailed description in conjunction with the accompanying drawings, in which:

FIG. 1 is an elevational view of a suction (convex profile) side of an turbine engine blade, in accordance with an exemplary embodiment;

FIG. 2 is a fragmentary perspective view of the airfoil suction side trailing edge (TE), proximate the hub, of the blade of FIG. 1, and further showing the increased outer wall thickness zone profile and the hub fillet joining the airfoil side wall and the blade platform;

FIG. 3 is plan cross sectional view in the increased thickness zone through a TE cooling slot between two pedestals, taken along 3-3 of FIG. 2;

FIG. 4 is a fragmentary perspective view of the airfoil pressure (concave) side trailing edge (TE), in the increased thickness zone proximate the hub, of the blade of FIG. 1, and further showing the TE cooling slot with the pedestals in partial end view;

FIG. 5 is a partial cut-away elevational section of the hub end pedestals and cooling passages in the increased thickness zone, taken along 5-5 of FIG. 4;

FIG. 6 is an enlargement of FIG. 5, showing the eight lowest pedestals that are proximate the blade hub, which includes those in the increased thickness zone;

FIG. 7 is a plan cross section through the fourth pedestal in the increased thickness zone, through its major axis, including its compound curve pedestal fillets, taken along 7-7 of FIG. 6;

FIG. 8. is an enlarged elevational cross section through the fourth pedestal of FIG. 6, showing the compound curve pedestal fillet which joins the pedestal to the interior surface of the outer wall or side wall of the airfoil pressure side, which view is also taken along 8-8 of FIG. 7;

FIG. 9 is a plan cross section through a cooling slot between the second and third pedestals in the increased thickness zone, which is similar to the perspective view of FIG. 3, showing relative differences in increased airfoil outer wall or side wall thickness T_{H} of the zone proximate the TE and hub, compared to corresponding wall thickness T_{T} in the TE outboard of the zone and closer to the blade tip, represented by the phantom profile lines; and

FIG. 10 is an enlarged cross sectional elevational view of the lowermost pedestal of FIG. 6, which is in the increased thickness zone.

To facilitate understanding, identical reference numerals have been used, where possible, to designate identical elements that are common to the figures. Any reference designation “XX/YY” indicated that the associated lead line is directed to both of the elements XX and YY. The figures are not drawn to scale.

### DETAILED DESCRIPTION

Exemplary embodiments of the invention are utilized in gas turbine engine rotating blades. More particularly, such blades having an increased airfoil outer wall or side wall thickness zone proximate the hub and trailing edge (TE), which reduces blade cracking propensity and enhances blade service life. Airfoil TE wall thickness in this zone proximate the hub is forty to sixty percent (40-60%) greater than the comparable greatest wall thickness anywhere else along the trailing edge from outboard that zone all the way to the blade tip. In many embodiments, the TE outer wall thickness proximate the blade tip and outboard or above the zone remains constant or tapers to reduced thickness along the span or stand length to the tip. The increased thickness zone generally comprises eight to ten percent (8-10%) of the total blade stand height. In some embodiments, the corresponding outer wall thickness in the increased thickness zone transitions from the thicker region proximate the hub to that of the outboard thinner region that is proximate the tip for an additional five to seven percent (5-7%) of the total blade span or stand height. In some embodiments, the increased thickness zone incorporates the first five to eight TE pedestals. In some embodiments, such pedestals also incorporate compound curve fillets in the increased outer wall thickness zone or in any other desired zone. The increased outer wall or side wall thickness zone reduces blade cracking propensity and enhances service life.

The increased outer wall thickness zone invention embodiments are adaptable to upgrade existing blade designs, by incorporating a thicker airfoil outer wall or side wall in the TE at the hub, and modifying the existing hub fillet profile. The thicker trailing edge zone reduces blade stress, which improves its LCF life. In cast superalloy blades embodiments, the thicker outer wall zone modification not only reduces the average stress, due to the larger bearing area, but also creates simultaneously a more desirable grain structure at this location by changing the liquid metal solidification rate. The thicker casting wall in the hub/TE zone advantageously also enhances grain size. Large grains reduce the number of inter granular zones that might otherwise be susceptible to crack formation. The resulting TE wall thickness zone exhibits better creep ductility properties that further retard concentrated creep stress induced crack initiation and propagation.

Some embodiments of the invention incorporate larger pedestal compound fillets, which additionally reduce stress concentration in the lower TE zone proximate the hub, and raise the fatigue life of the blade. In some embodiments, the pedestal fillet incorporates a compound fillet, in order to maintain sufficient interior cavity volume in the blade airfoil for delivery of blade coolant to the trailing edge, while still maximizing stress concentration reduction.

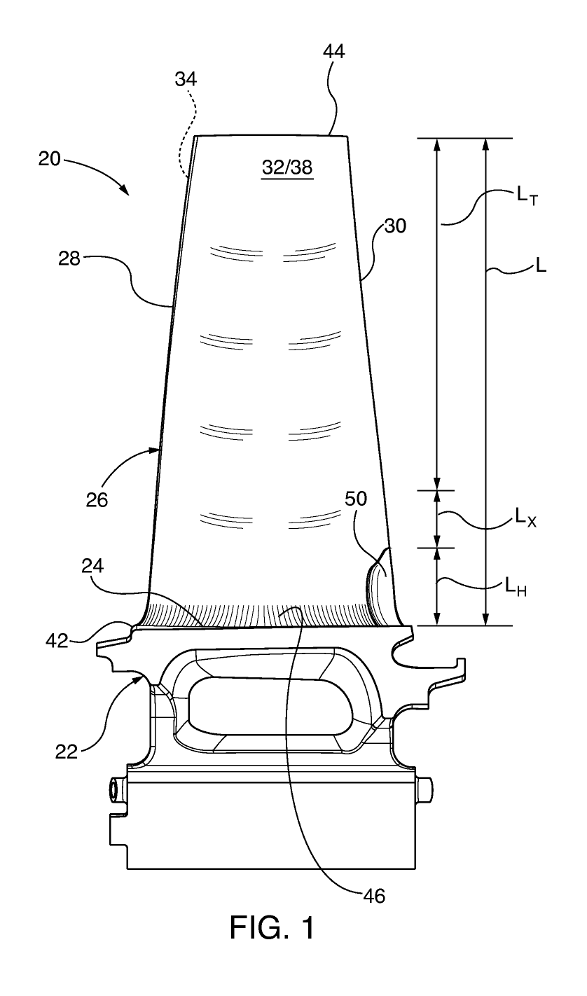

FIGS. 1-3 show an exemplary gas turbine engine rotating blade 20 embodiment. The blade 20 has a hub portion 22, a blade platform 24, and an airfoil portion 26, which is coupled to the hub portion along the blade platform. The airfoil 26 has a leading edge (LE) 28 and a trailing edge (TE) 30. The airfoil outer profile includes a suction (convex) side 32, and a pressure (concave) side 34. The airfoil has an outer wall 36, which is also sometimes referred to as a side wall, which delimits an outer wall exterior surface 38 an outer wall interior surface 40, an airfoil hub end 42, and an airfoil tip 44. Airfoil span or stand dimension, L, which is also referred to as airfoil height or airfoil length dimension, is delimited by the airfoil outer wall 36 from its hub end 42 to the end of its blade tip 44.

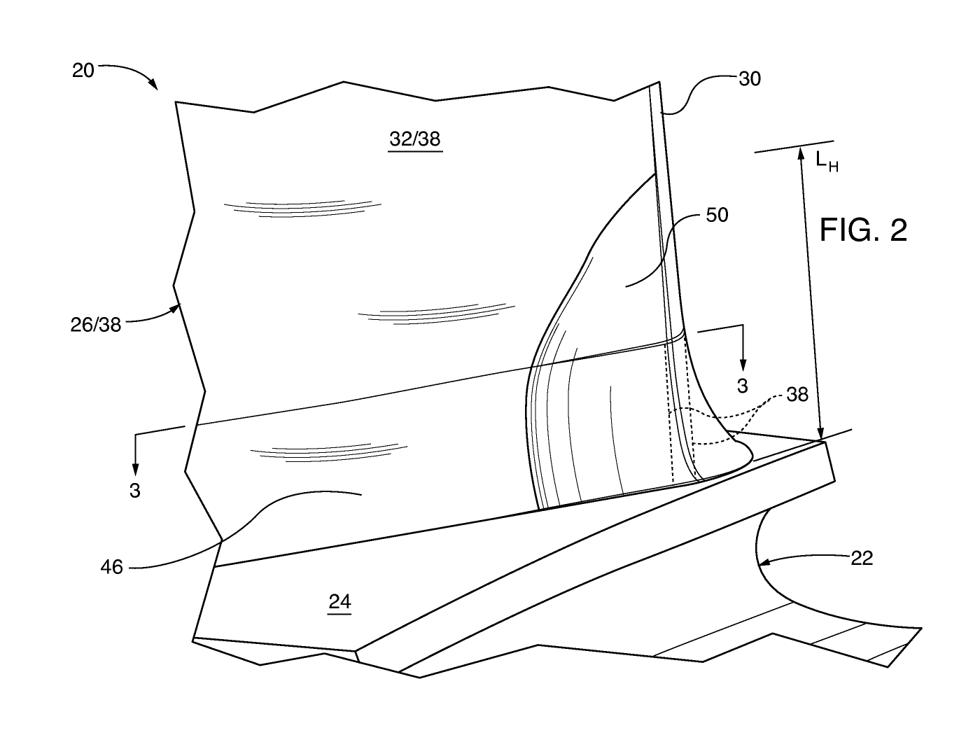

As shown in FIG. 2, the blade 20 has a hub fillet 46 circumscribing and joined to the airfoil outer wall exterior surface 38 at the proximal or hub end 42, which is also joined to the blade platform 24. In a turbine blade casting, the hub fillet 46 is integrally cast with the airfoil outer wall exterior surface 38 and the blade platform 24, adding extra material thickness to the blade region where the exterior surface of the hub outer wall and the blade platform converge. However, as shown in the dotted lines 38 of FIG. 2, the airfoil outer wall exterior surface 38 is defined as running continuously from the blade platform 24 to the blade tip 44, with the hub fillet 46 being considered as additional material thickness outboard of that exterior surface. While cast superalloy blade embodiments have been discussed so far, blade embodiments herein include blades cut from a homogeneous billet or forgings, fabricated from joined subcomponents, or fabricated by sequential layer additive manufacturing techniques, such as 3-D printing.

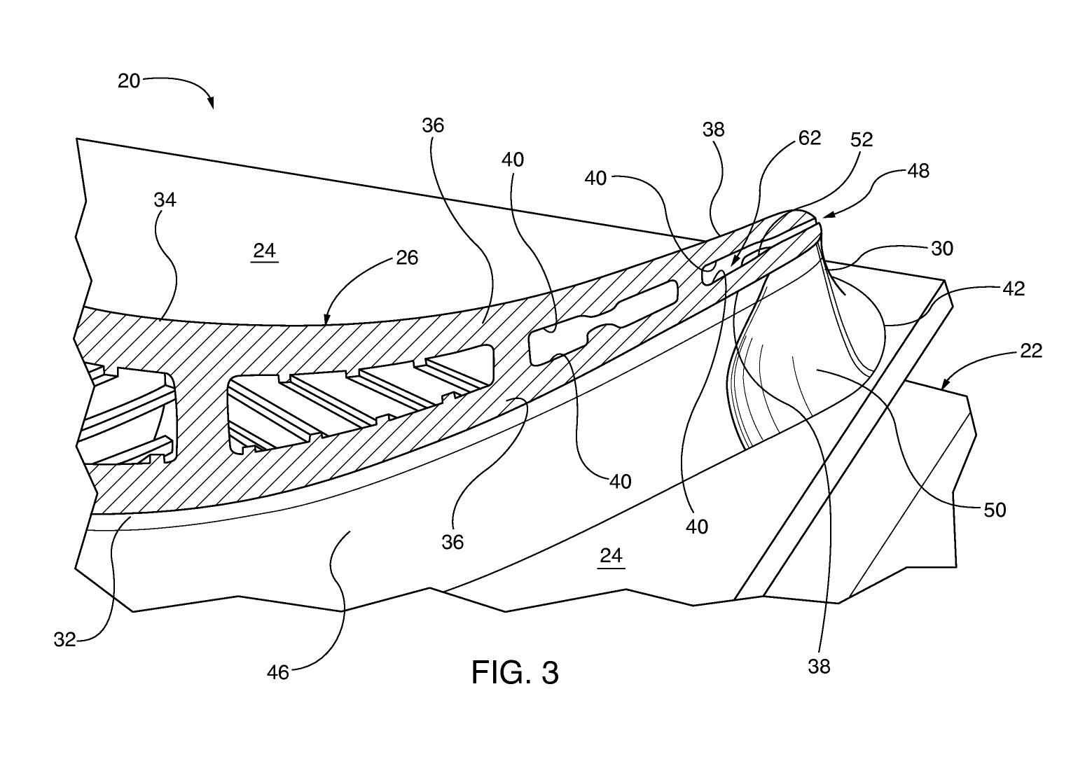

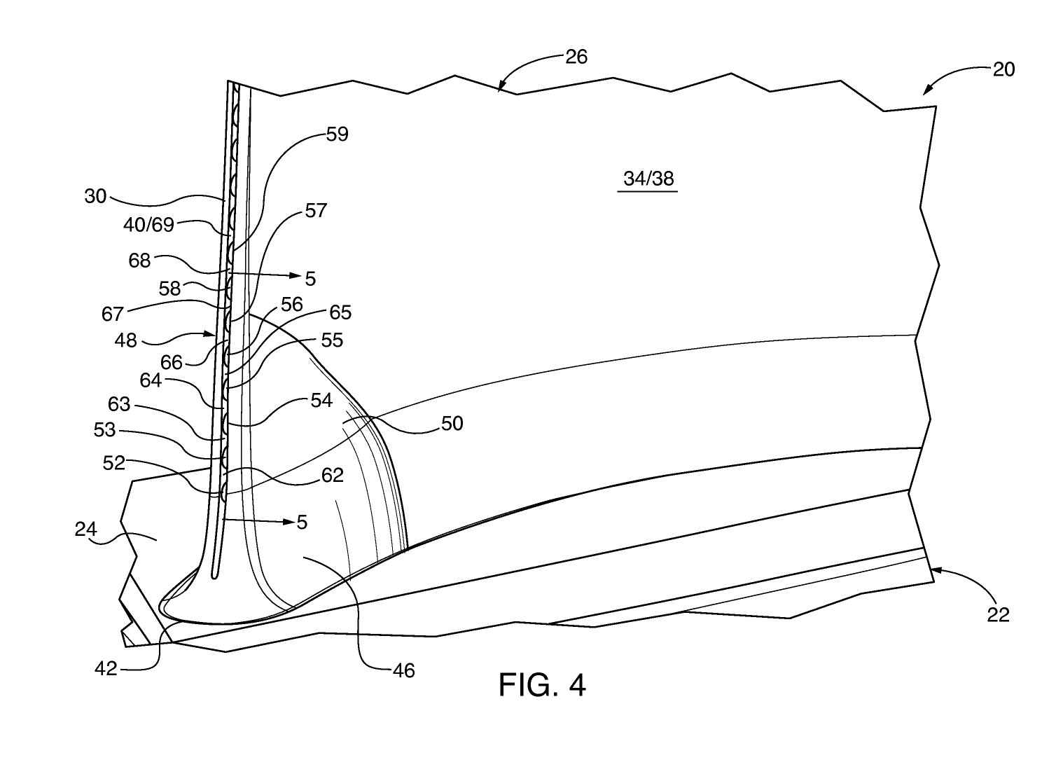

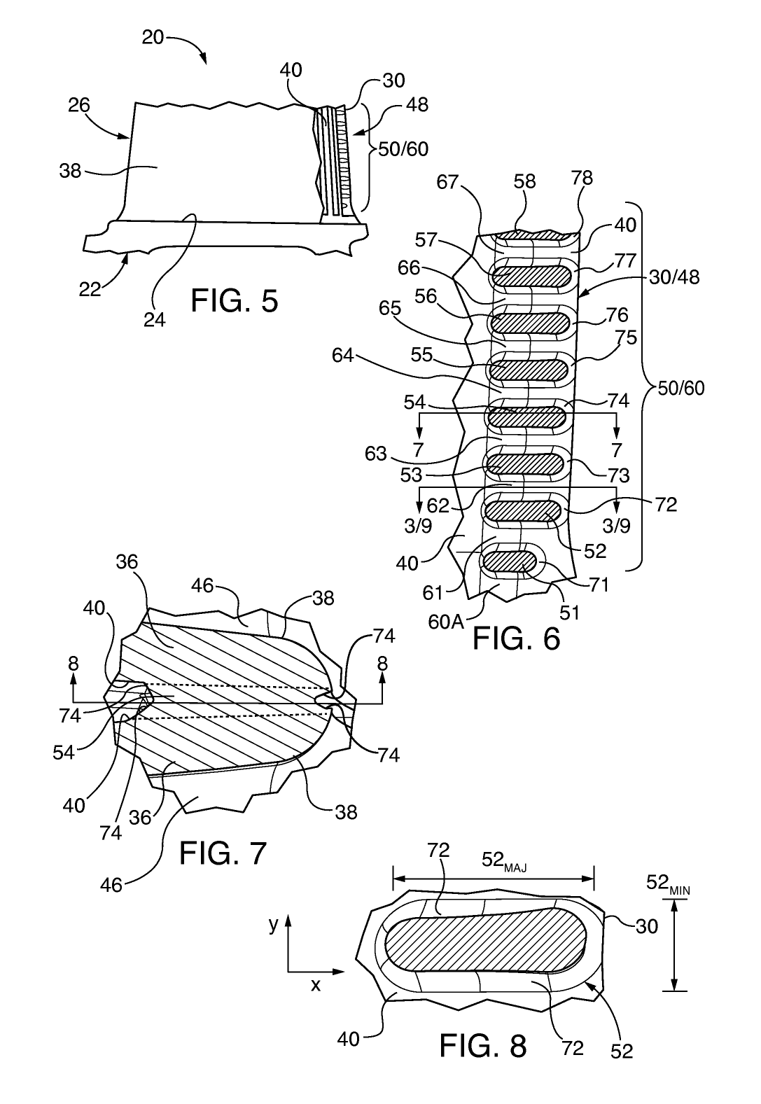

Referring to FIGS. 3-6, the blade 20 defines a trailing edge cooling slot 48, which is formed between opposed interior walls or surfaces 40 of the airfoil outer wall 36. The TE cooling slot 48 is in communication with passages or cavities within the airfoil interior delimited by the outer wall interior surfaces 40, for passage of cooling fluid, such as water or compressed air, out of the blade TE 30. In this embodiment, a plurality of elongated pedestals 51-59 span the airfoil interior, and are oriented along the airfoil stand length L between the proximal (hub) 42 and distal (blade tip) ends 44. Other pedestals are oriented along the TE 30 to the blade tip. Depending upon a particular blade design, additional airfoil interior wall spanning pedestals are oriented within other areas of the airfoil interior. Cooling passages 60A and 61-69 are formed between opposed pedestals 51-59 in the TE cooling slot 48, so that cooling fluid can communicate with and cool the trailing edge 30.

Referring to FIGS. 7-10, the respective pedestals 51-58 have an elongated cross section. As shown in FIG. 8 the exemplary pedestal 52, defines a major axis 52_{MAJ} that is generally perpendicular to span or stand length dimension of the airfoil. The pedestal 52 defines a minor axis 52_{MIN} that is generally parallel with the airfoil span or stand length dimension. First and second ends of each respective pedestal 51-59, and if desired, any other pedestal, is coupled to respective corresponding opposed interior surfaces 40 of the outer wall pressure side 34 and suction side 32 proximate the trailing edge 30, by pedestal fillets, such as corresponding pedestal fillets 71-78. In some embodiments, such as shown in FIGS. 6-10, the pedestal fillets 71-78 have compound curve profiles, which can be viewed in the exemplary compound curve fillet 71 of FIG. 10. As previously noted, compound curve fillets maximize stress concentration reduction while minimizing fillet volume, so that there remains sufficient open cross sectional volume in the blade airfoil cooling passages 60A, 60-69, etc., for delivery of blade coolant to the trailing edge 30.

As previously noted, the airfoil 26 has an increased airfoil side wall or outer wall 36 thickness zone 50, excluding any adjoining hub fillet 46 thickness, which is also proximate the trailing edge 30. As shown in FIG. 1, the greater outer wall thickness zone 50 has a proximal end, which initiates at the airfoil proximal or hub end 42 and runs upwardly along the blade stand for approximately eight to ten percent (8-10%) of the total airfoil span, or stand length dimension, which is denoted by L_{H}. The zone L_{H} comprises the greatest outer wall thickness within the zone 50. Also included in the increased outer wall thickness zone 50, above or outboard the span or stand length dimension, L_{H}, is a transition zone span or stand length dimension, denoted by Lx, where the corresponding outer or side wall thickness decreases incrementally until merger with the outer wall's distal trailing edge zone, to the blade tip end 44, which is denoted by L_{T}. The increased thickness zone 50 distal end terminates at the outboard-most end of the transition zone Lₓ. The distal tip trailing edge portion, outboard of the increased wall thickness zone 50, which is denoted by L_{T}, constitutes between approximately eighty-three to eighty-seven percent (83-87%) of total airfoil span or stand length dimension, L. In an exemplary embodiment, the total blade TE 30 span or stand length L is 258 mm. The increased TE 30 outer wall thickness zone 50 span or stand length L incorporates the full increased wall thickness portion L_{H} span of 22 mm as well as the transition zone span L_{X} of 18 mm. The remaining trailing edge 30, outboard of the distal end of the increased wall thickness zone 50 to the blade tip 44, has a span or stand length, L_{T}, which is 240 mm.

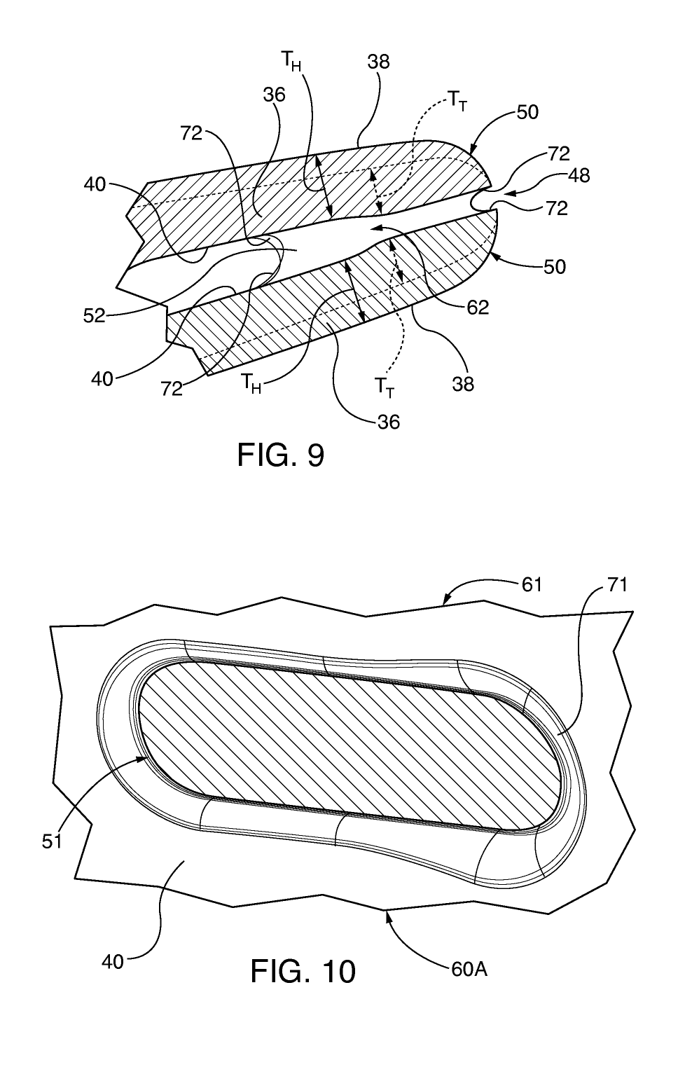

Relative differences in airfoil outer wall or side wall thickness zone 50 along the trailing edge 30 are defined as follows, referring to the blade cross section of FIG. 9. In the increased outer wall thickness zone 50, the airfoil outer wall thickness T_{H}, excluding adjoining hub fillet 46 thickness, is approximately forty to sixty percent (40-60%) greater along the trailing edge 30 (in the stand length L_{H}) than the comparable greatest wall thickness, T_{T}, anywhere else along the trailing edge 30 from outboard that zone 50 all the way to the blade tip 44 (i.e., in the span L_{T}). The blade cross section of FIG. 9, as well as those of FIGS. 3 and 7, is above the hub fillet 46, so the hub fillet 46 does not increase corresponding side wall thickness zone 50 shown in those figures. In some embodiments, the outer wall thickness T_{H} is constant in the L_{H} stand length portion of zone 50. To assist greater comprehension of the respective local relative airfoil outer wall or side wall 36 thicknesses in these described embodiments, FIG. 9 shows the actual wall thickness T_{H} in the increased thickness zone 50 in the cross section taken through cooling passage 62, which is delimited by the outer wall exterior surface 38 and the interior surface 40. Corresponding thickness T_{T} for the distal tip stand length L_{T} region (outboard of the increased thickness zone 50) is shown in the dotted lines inboard of the actual outer wall exterior surfaces 38. As noted above, corresponding airfoil outer wall or side wall thickness in the transition zone (in the span or stand length L_{X}) transitions from that of the adjoining greatest increased wall proximate the hub platform 24, i.e., in the proximal portion within the thickness zone 50, to the corresponding distal end of the increased thickness zone's thickness of the outboard adjoining outer wall thickness T_{T} in the stand length L_{T}. Actual absolute thickness or any thickness variations in the trailing edge 30 portion outer wall thickness T_{T}, outboard the thickness zone 50 out to the blade tip 44, along the span or stand length L_{T} is constant, or varied, such as by tapering to thinner thickness toward the end of the blade tip 44.

In the embodiment of FIG. 6, the increased outer wall thickness zone 50 incorporates the five lowest pedestals 51-55 in stand length L_{H}, and the transition zone L_{X} the sixth and seventh lowest pedestals 56-57. The eighth pedestal 58 is in the tip wall thickness zone L_{T}. The exact number of pedestals in each wall thickness zone 50 is selectively varied during design, depending upon the blade geometry, airfoil outer wall thickness, needed cross sectional area for trailing edge cooling passages 48, and the anticipated turbine engine operating conditions.

Beneficially an existing blade design can be upgraded to a design incorporating the present invention by reconfiguring the blade trailing edge 30 proximate its hub to include the increased thickness zone 50, along with an incorporated transition thickness zone that merges with the existing blade distal trailing edge 30 thickness profile above or outboard of that zone. Pedestals constructed in accordance with the embodiments herein can be included in the increased thickness zone 50.

Increased trailing edge outer wall thickness in the zone 50 directly changes the relative casting solidification rates of the airfoil trailing edge 30 and the blade platform 24 mass in a direction that results in improved grain structure from the casting process. This improvement increases the concentrated rupture capability as confirmed by microstructural evaluations and elevated temperature concentrated creep rupture testing. These comparisons of a thickened TE 30 blade casting, with the zone 50, as compared to nominal thickness blade castings, confirmed the effects on concentrated rupture capability. Grain size affects the crack initiation and propagation in the concentrated stress areas. Increased airfoil outer wall 38 thickness in the zone 50 directly influences these formations in a positive direction, by changing relative solidification rate to reduce the formation of fine grains that result in reduced ductility and corresponding concentrated creep rupture capability.

Although various embodiments that incorporate the invention have been shown and described in detail herein, others can readily devise many other varied embodiments that still incorporate the claimed invention. The invention is not limited in its application to the exemplary embodiment details of construction and the arrangement of components set forth in the description or illustrated in the drawings. The invention is capable of other embodiments and of being practiced or of being carried out in various ways. in addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted”, “connected”, “supported”, and “coupled” and variations thereof are used broadly and encompass direct and indirect mountings, connections, supports, and couplings.

What is claimed is:

1. A turbine engine blade, comprising:
a hub, including a blade platform;
an elongated airfoil portion, having:
an outer wall delimiting a pressure side, a suction side, a leading edge, and a trailing edge on an exterior surface thereof, an airfoil interior on an interior surface thereof, and an outer wall thickness between the respective interior and exterior surfaces;
a proximal end of the outer wall coupled to the blade platform from the leading edge to the trailing edge;
a distal end of the outer wall defining a blade tip; and
airfoil span defined between the proximal and distal ends thereof;
a hub fillet circumscribing and joined to the airfoil outer wall exterior surface at the proximal end thereof, and joined to the blade platform; and
an increased airfoil outer wall thickness zone, having a zone proximal end adjoining the blade platform and a zone distal end, wherein the zone outer wall thickness, excluding adjoining hub fillet thickness, is approximately forty to sixty percent (40-60%) greater along the trailing edge for approximately eight to ten percent (8-10%) of total airfoil span most proximate the hub than comparable greatest outer wall thickness anywhere else along the trailing edge from outboard the zone distal end all the way to the blade tip, with outer wall thickness at the zone distal end transitioning to that of the adjoining outboard outer wall thickness.

2. The turbine engine blade of claim 1, further comprising a compound curve hub fillet circumscribing and joined to the airfoil outer wall exterior surface at the proximal end thereof, and joined to the blade platform.

3. The turbine engine blade of claim 1, further comprising the distal end outer wall thickness along the trailing edge remaining constant for approximately eighty-three to eighty-seven percent (83-87%) of total airfoil stand length.

4. The turbine engine blade of claim 3, further comprising a plurality of pedestals spanning the airfoil interior, having first and second ends coupled to respective corresponding opposed interior surfaces of the outer wall pressure and suction sides proximate the trailing edge, the pedestals oriented along at least part of the airfoil stand length between the proximal and distal ends thereof.

5. The turbine engine blade of claim 4, further comprising first and second compound curve pedestal fillets coupling the respective pedestal first and second ends to their corresponding opposed interior surfaces.

6. The turbine engine blade of claim 5, at least one pedestal having an elongated cross section, defining a major axis that is generally perpendicular to stand length dimension of the airfoil, and a minor axis that is generally parallel with the airfoil span dimension.

7. The turbine engine blade of claim 4, the airfoil interior proximate the trailing edge defining a cooling gap between the opposed outer wall interior surfaces, for passage of cooling fluid there through, the pedestals spanning the cooling gap.

8. The turbine engine blade of claim 4, having five pedestals in the airfoil proximal end eight to ten percent (8-10%) of airfoil stand length, and at least two pedestals in a zone of outer wall transitioning thickness intermediate the respective proximal end and distal end thicknesses.

9. The turbine engine blade of claim 3, the airfoil interior proximate the trailing edge defining a cooling gap between the opposed outer wall interior surfaces, for passage of cooling fluid there through, the pedestals spanning the cooling gap.

10. The turbine engine blade of claim 1, further comprising a plurality of pedestals spanning the airfoil interior, having first and second ends coupled to respective corresponding opposed interior surfaces of the outer wall pressure and suction sides proximate the trailing edge, the pedestals oriented along at least part of the airfoil stand length between the proximal and distal ends thereof.

11. The turbine engine blade of claim 10, further comprising first and second compound curve pedestal fillets coupling the respective pedestal first and second ends to their corresponding opposed interior surfaces.

12. The turbine engine blade of claim 10, having five pedestals in the airfoil proximal end eight to ten percent (8-10%) of airfoil stand length, and at least two pedestals in a zone of outer wall transitioning thickness intermediate the respective proximal end and distal end thicknesses.

13. The turbine engine blade of claim 1, the airfoil interior proximate the trailing edge defining a cooling gap between the opposed outer wall interior surfaces, for passage of cooling fluid there through, the pedestals spanning the cooling gap.

14. A turbine engine blade, comprising:
a hub, including a blade platform;
an elongated airfoil portion, having:
an outer wall delimiting a pressure side, a suction side, a leading edge, and a trailing edge on an exterior surface thereof, and an airfoil interior on an interior surface thereof, and an outer wall thickness between the respective interior and exterior surfaces;
a proximal end of the outer wall coupled to the blade platform from the leading edge to the trailing edge;
a distal end of the outer wall defining a blade tip;
airfoil span defined between the proximal and distal ends thereof;
a compound curve hub fillet circumscribing and joined to the airfoil outer wall exterior surface at the proximal end thereof, and joined to the blade platform;
a plurality of elongated pedestals spanning the airfoil interior, oriented along the airfoil stand length between the proximal and distal ends thereof, the pedestals respectively having:
an elongated cross section, defining a major axis that is generally perpendicular to stand length dimension of the airfoil, and a minor axis that is generally parallel with the airfoil stand length dimension,
first and second ends coupled to respective corresponding opposed interior surfaces of the outer wall pressure and suction sides proximate the trailing edge, by pedestal fillets; and
an increased airfoil outer wall thickness zone, having a zone proximal end adjoining the blade platform and a zone distal end, wherein the zone outer wall thickness, excluding adjoining hub fillet thickness, is approximately forty to sixty percent (40-60%) greater along the trailing edge for approximately eight to ten percent (8-10%) of total airfoil span most proximate the hub than comparable greatest outer wall thickness anywhere else along the trailing edge from outboard the zone distal end all the way to the blade tip, with outer wall thickness at the zone distal end transitioning to that of the adjoining outboard outer wall thickness.

15. The turbine engine blade of claim 14, further comprising the distal end outer wall thickness along the trailing edge remaining constant for approximately eighty-three to eighty-seven percent (83-87%) of total airfoil stand length.

16. The turbine engine blade of claim 15, having five pedestals in the airfoil proximal end eight to ten percent (8-10%) of airfoil stand length, and at least two pedestals in a zone of outer wall transitioning thickness intermediate the respective proximal end and distal end thicknesses.

17. The turbine engine blade of claim 14, having five pedestals in the airfoil proximal end eight to ten percent (8-10%) of airfoil stand length, and at least two pedestals in a zone of outer wall transitioning thickness intermediate the respective proximal end and distal end thicknesses.

18. The turbine engine blade of claim 14, further comprising first and second compound curve pedestal fillets coupling the respective pedestal first and second ends to their corresponding opposed interior surfaces.

19. The turbine engine blade of claim 18, the airfoil interior proximate the trailing edge defining a cooling gap between the opposed outer wall interior surfaces, for passage of cooling fluid there through, the pedestals spanning the cooling gap.

20. The turbine engine blade of claim 14, the airfoil interior proximate the trailing edge defining a cooling gap between the opposed outer wall interior surfaces, for passage of cooling fluid there through, the pedestals spanning the cooling gap.
